(19) United States
(12) Patent Application Publication
(10) Pub. No.: US 2026/0189393 A1
(43) Pub. Date: Jul. 2, 2026

(54) Authentication via Merkle Tree Zero-Knowledge Proof and Proof-of-Work

(71) Applicants: Kangjia Huang, Cupertino, CA (US); Alan Yu, San Jose, CA (US)

(72) Inventors: Kangjia Huang, Cupertino, CA (US); Alan Yu, San Jose, CA (US)

(21) Appl. No.: 19/436,405

(22) Filed: Dec. 30, 2025

Related U.S. Application Data
(60) Provisional application No. 63/739,678, filed on Dec. 30, 2024.

(51) Int. Cl. H04L 9/32

(52) U.S. Cl. CPC H04L 9/3218; H04L 9/3213

(57) ABSTRACT

Herein is disclosed a method of generation by the client of blocks of data unique to the user's credentials, and a method of use of the irrecoverable blocks of data in leaf hashes in a Merkle tree, in order to enable secure zero-knowledge authentication with low server-side computational costs while effectively increasing brute-force resistance.

### CROSS-REFERENCE TO RELATED APPLICATIONS

This application claims the benefits of U.S. Provisional Patent Application No. 63/739,678, filed on Dec. 30, 2024, which is incorporated herein by reference in its entirety.

### STATEMENT REGARDING FEDERALLY SPONSORED RESEARCH OR DEVELOPMENT

Not Applicable.

### REFERENCE TO A SEQUENCE LISTING, A LARGE TABLE, OR A COMPUTER PROGRAM LISTING APPENDIX ON READ-ONLY OPTICAL DISC

Not Applicable.

### BACKGROUND OF THE INVENTION

The need for a secure method to authenticate users over the internet has been prevalent ever since the transition to online services. Passwords have been the core method of controlling access to personal data, payments, and identities. However, secure implementation of such systems has been a prevalent issue; current implementations rely on a computation called a cryptographic hash to verify a password without storing the password itself. For password authentication, this is typically made computationally expensive—a so-called “slow” hash function—to reduce attack viability in case of a data breach. Functions such as bcrypt are designed and widely used for this express purpose.

However, these “slow” hash functions are often intentionally costly, taking a significant time to compute, to prevent so-called “brute forcing” against data recovered from a data breach. If this computational cost is reduced in traditional systems, brute-forcing becomes easier until it is no longer secure. Thus, the current widely-accepted view is that parties wishing to authenticate users (for instance, servers hosting applications) must store hashes with as much computational cost as is capable for the server to compute in a reasonable amount of time (typically, one second), so as to maximize security without severely degrading user performance. However, this tradeoff often may not be ideal—most notably, it would still worsen user credential security when the hash function needs to be tuned to lower computational costs due to server load concerns.

The present invention aims to primarily reduce server-side computational costs associated with slow hash verification for authentication while maintaining brute-force resistance; however, due to its properties, there are also several additional benefits and areas of extensibility, which will be discussed in further detail throughout the description.

The core ability of the invention to reduce server-side computational cost is founded upon a Proof-of-Work system. Proof-of-work systems, especially prevalent in blockchain, provide a means for a provider of a service to verify that adequate computational work has been done by a requester before granting access to said service. However, one interesting consequential property of such a system is that for it to be viable, the provider must do significantly less work than the requester in proof verification—particularly if the demanded work is intensive.

Though much work has been done implementing a variety of Proof-of-Work systems based on different underlying theories and mechanisms, one particular implementation suggested by F. Coelho in a 2007 paper (doi: 10.1007/978-3-540-68164-9_6) is of unique value to the invention. Coelho's implementation of the Proof-of-Work system relies on a data structure known as a Merkle tree—a binary tree where each node contains a cryptographic hash of the hashes in its children nodes. The bottommost (“leaf”) nodes of this tree are hashes of arbitrarily defined data. Due to the nature of this data structure, however, the proof derived therein may function not only as a Proof-of-Work, but also as a Zero-Knowledge Proof—allowing the requester to prove to the provider that they know a given secret, without revealing meaningful information about said secret.

Based on Coelho's work, it is already known that the Proof-of-Work system enabled by the Merkle tree allows for significantly less work done on the server. First, note that since the value of a node only depends on the values of its immediate children, it is possible to build a tree with a given hash at the root node (“root hash”) R without knowing the values of all nodes (see example in FIG. 7)—a “partial tree”. Thus, after the client builds a full tree (which shall be computationally expensive), it only needs to send a subset of the nodes (in the form of a partial tree) to the server, such that the server can trivially build a partial tree to verify the root hash. Much of the motivation behind the technique is detailed in Coelho's paper. However, the capability of such a data structure to generate a zero-knowledge proof in addition to this kind of proof-of-work, an aspect developed in the present invention, is nontrivial and involves significant modification and extension upon this base technique.

### BRIEF SUMMARY OF THE INVENTION

In one form, the present disclosure provides a method of generation by the client of blocks of data unique to the user's credentials, which are irrecoverable from said blocks, and the recovery of one block does not reveal subsequent blocks; such blocks of data are used for leaf hashes in a Merkle tree.

In another form, the present disclosure provides a method of implementing a proof-of-work and zero-knowledge proof mechanism by using said Merkle tree.

In a further form, the present disclosure provides a protocol that can be used to implement secure authentication using the aforementioned methods of generation of blocks of data and hash calculation in the Merkle tree, which reduces server-side computational costs typically associated with credential verification while effectively improving brute-force resistance.

### BRIEF DESCRIPTION OF THE SEVERAL VIEWS OF THE DRAWINGS

FIG. 1: Reference build process of proof-of-work performed by client.

FIG. 2: Reference verify process of proof-of-work performed by server.

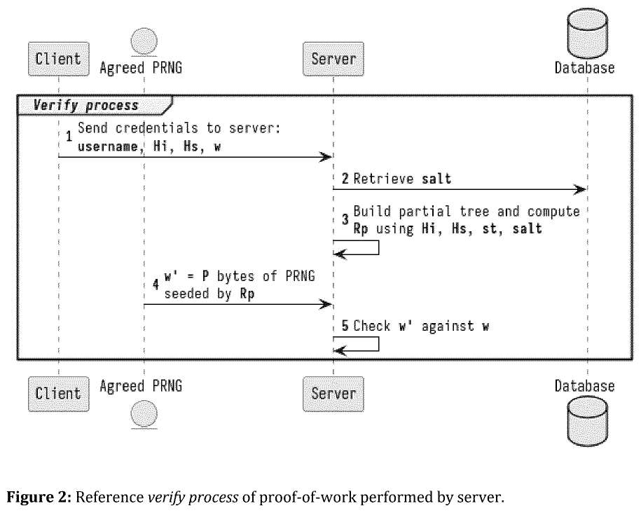

FIG. 3: Registration process.

FIG. 4: Authentication process.

FIG. 5: Change of credentials process.

FIG. 6: Merkle tree construction process.

FIG. 7: Client proof-of-work construction process.

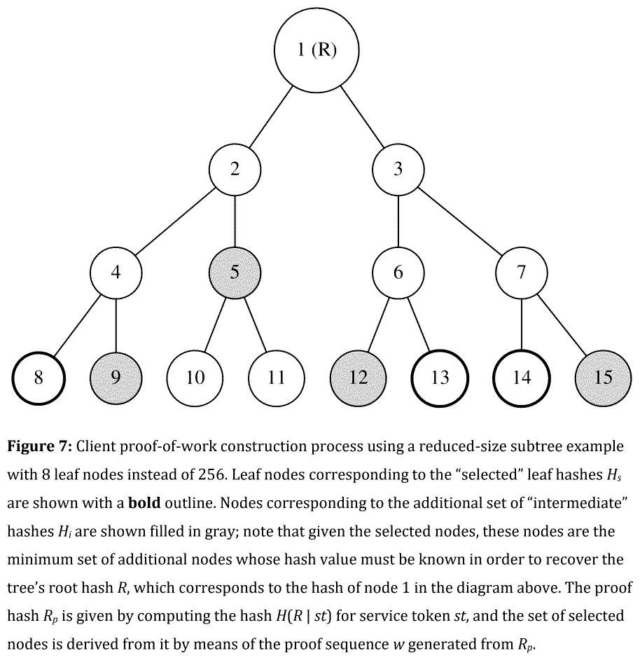

### DETAILED DESCRIPTION OF THE INVENTION

For the purpose of promoting an understanding of the principles of the present disclosure, reference is made to the embodiments illustrated in the drawings as described below. The embodiments disclosed herein are not intended to be exhaustive or to limit the disclosure to the precise form disclosed in the following detailed description.

In some embodiments, the Merkle tree used in this protocol contains 256 leaf nodes (however, for general implementations, any number of nodes that is a power of 2 will theoretically suffice). The resulting size of the tree (511 nodes, or generally 2n-1 nodes for n leaf nodes) thus necessitates a slow hash function H for calculating each node hash with a cost factor tuned such that 512 (or 2n) sequential hash operations equate to a single operation at currently acceptable cost factors. For the well-known bcrypt hash function, for instance, 512=2⁹ iterations of the hash effectively raises the cost factor by 9. Thus, given that a cost factor of at least 12 is generally recommended, considering limitations by various common implementations, a cost factor of 4 could be used for hash calculation per node, yielding an effective cost factor of 4+9=13 in building the full tree.

In some embodiments, given these requirements, the means by which certain hashes in the Merkle tree are derived must be considered. Note that for the tree construction to satisfy the equivalent computational work of a secure slow hash function, as previously mentioned, the hash of each node in the tree must be computed in sequence. Unfortunately, note that so long as the data blocks from which the tree is constructed are independent of the

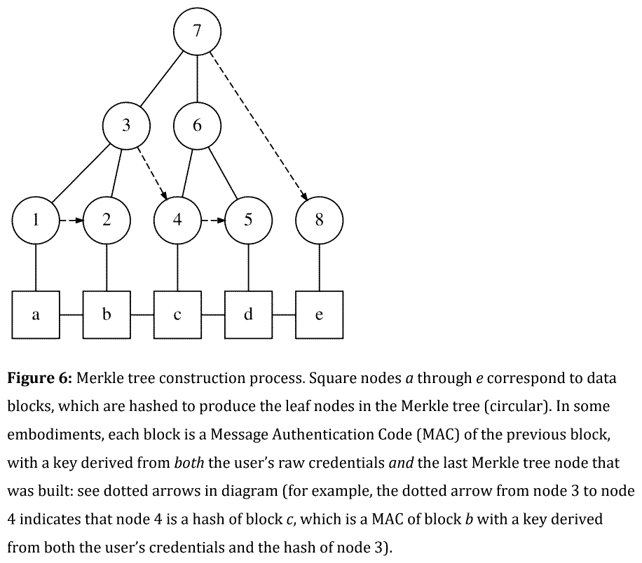

tree itself, the Merkle tree alone is extremely parallelizable. In particular, all node hashes on each layer can theoretically be computed simultaneously: each node's hash only depends on that of its two children, with no direct dependency or relationship between any nodes on the same layer. Thus, in order to address this, nodes in the tree must be computed in a “linked” manner, where the computation of a particular node requires computation of the nodes before it; the exact process is detailed in FIG. 6, and discussed in greater detail within the build process section below.

Additionally, note that as a requirement, a given proof sent between client and server generally should not be reusable (which would defeat the very purpose of the proof, enabling trivial replay attacks). Coelho's protocol achieves this by requiring the use of service descriptors requested by the client that avoid collisions—for instance, by incorporating a nonce into the descriptor. However, this method would be infeasible with the invention, as the corresponding component in this protocol would be the user's credentials themselves. In some embodiments, proof reuse resistance is thus achieved through the use of an updating “service token” st, provided by the server, which is combined with the root hash of the tree in generating the proof. The technique by which this is achieved is detailed in the description of the build process section below.

The authentication protocol is thus as follows. First, we shall define terminology for some foundational processes of the core Proof-of-Work system that will later serve key roles within our authentication protocols:

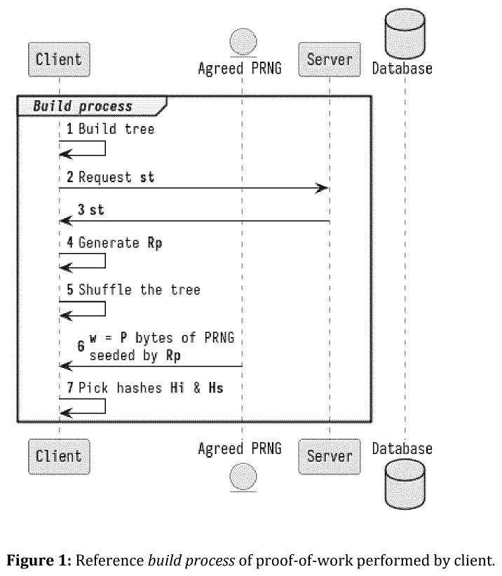

Build process. (FIG. 1) To begin a process that shall henceforth be referred to as the “build process,” the client will first generate blocks of data unique to the user's credentials (1), which shall be hashed to produce the leaf node hashes of the Merkle tree. In some embodiments, to prevent recovery of the user's credentials, subtrees of the Merkle tree are computed greedily (as soon as the necessary leaf hashes are present), and the data blocks corresponding to the leaf hashes are generated with iterated Message Authentication Codes (MACs), with credential information along with the most recently computed node hash in the Merkle tree as necessary information to provide the key for the operation. Regardless of the particular embodiment, however, the core purpose is to ensure that the recovery of one block used to generate a leaf hash does not allow the recovery of other leaf hashes in the tree, and that the generation of nodes within the tree must be performed sequentially as aforementioned (see FIG. 6).

When the full tree has been constructed in this manner, let the root hash of the tree then be R. In some embodiments, the client will first request the service token st from the server (2, 3), specific to the user, and then compute a “proof hash” Rₚ=H(R|st), where “|” denotes concatenation (as described in 4 of FIG. 1). The client shall then derive a so-called “proof sequence” w, a byte sequence of length P, for an adjustable parameter P that will be further discussed below (as described in 4 of FIG. 1). For instance, in some embodiments, the client may use a seeded pseudo-random number generator (PRNG) G, agreed upon by both client and server and seeded with Rp, to generate w.

In some embodiments, the client shall use w to select a set of leaf node hashes Hs, known as “selected hashes,” by treating each byte (0-255) in w as a left-to-right index into the 256 leaf nodes. (6) It shall then collect the minimal set of additional “intermediate” node hashes Hi necessary to build a partial tree and compute the root hash, such that every “intermediate” and “selected” node must be used in the computation (for instance, it would be pointless for any parent of a selected node to be an intermediate node, because the selected node would no longer be needed in computing the root hash), and send w, Hi, and Hs to the server. (7) This concludes the build process for the client.

Verify process. In some embodiments, upon the server's receipt of w, Hi, and Hs, the server shall commence what will henceforth be referred to as the “verify process”: it shall reconstruct the partial tree with the given information, and recover the root hash R. Then, as was the case with the client, it generates the aforementioned Rp (as described in 6 of FIG. 1), and uses it to seed G and generate w′ in the same manner as w (as described in 7 of FIG. 1). If w′ is identical to w (as described in 8 of FIG. 1), the server now has assurance beyond reasonable doubt that the client faithfully performed significant computational work in constructing the tree, and the verify process succeeds (attacks are possible, though rendered highly improbable with proper parameter choice; see Coelho's paper for further discussion). If not, the server may take necessary action (in the context of authentication, for example, a server would consider this as grounds to reject the authentication attempt). However, note that this process itself does not guarantee the authenticity of the user's credentials.

Additionally, in some embodiments, when it is necessary for the server to update the service token st associated with a particular client user, it shall commence a process henceforth referred to as the “reroll process”: after having performed a successful verification process, while the server has access to the user's intermediate Merkle tree, it shall generate a new cryptographically secure st′ and recompute the “proof hash” Rₚ′=H(R|st′). This updated value Rₚ′ will serve to continue identifying the client, provided the new service token st′ is used.

The aforementioned fundamental elements of this challenge-response proof-of-work system are now sufficient to allow us to construct the full authentication protocol, which is as follows:

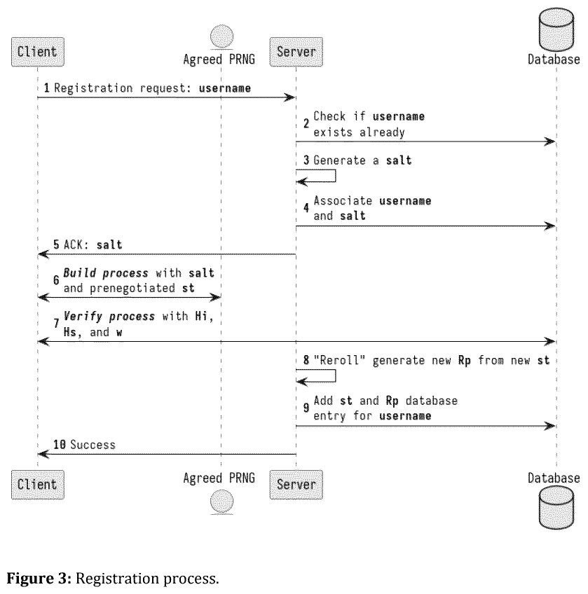

### Registration (FIG. 3)

In some embodiments, registration of a new user to a server occurs as follows:
1. The client shall make a request to the server initiating the registration process, providing the username that they wish to use. (1)
2. Assuming this username does not already exist, (2) the server shall initialize in its database an entry for the new user, consisting of their desired username and a cryptographically secure random salt used in all hashing done on client and server. (3, 4)
3. The server responds to the client, providing the newly created salt. (5)
4. The client then commences a build process with their credentials using the provided salt. However, rather than obtaining a service token st from the server (as one does not yet exist), the client shall use a pre-negotiated or otherwise well-defined magic st instead; for instance, in some embodiments, this may be a series of null bytes. (6)
5. Upon obtaining the resulting w, Hᵢ, and Hₛ, the client sends this information as usual to the server, which then commences a verify process using the client-provided values and the pre-shared st to ensure that the user's Merkle tree is structurally valid. Should this process fail, the server will reject the registration attempt. (7)
6. Upon success of the verify process, the server will commence a reroll process in order to generate initial values for st and Rp. (8) It shall record these values into the database, thus initializing the user's credentials. (9)
7. The server informs the client of successful registration. (10)

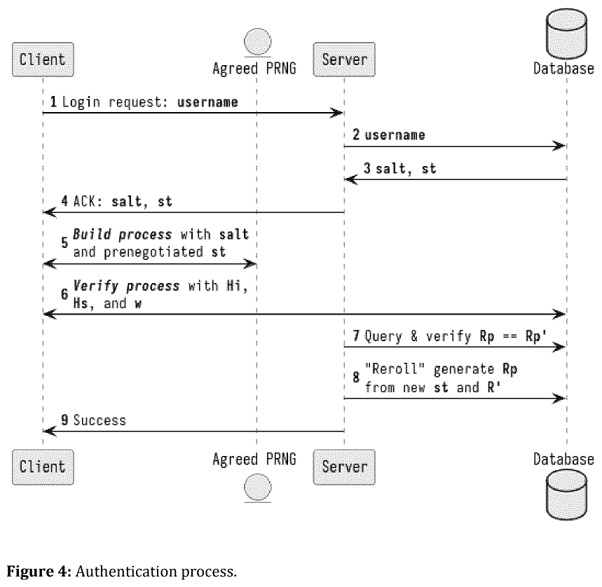

### Authentication (FIG. 4)

In some embodiments, authentication of an existing user to a server occurs as follows:
1. The client shall make a request to the server initiating the registration process, providing the username that they wish to authenticate as. (1)
2. Assuming the username is valid and exists within the database, the server shall look up the corresponding user entry within the database, (2) and respond to the client providing the user's salt and st for this authentication attempt. (3)
3. The client commences a build process with their credentials and the provided salt and st.
4. Upon completion of the build process, the client sends the computed w, Hi, and Hs to the server.
5. The server commences a verify process using the provided values and the st from the database user entry. Should this process fail, the server shall reject the authentication attempt.
6. Once the verify process succeeds, the server will compare the computed Rₚ from the process with the Rₚ recorded for the user in the database. Authentication of the user's credentials is valid if and only if the two values match; otherwise, the server shall reject the authentication attempt.
7. Upon successful validation of the user's credentials, the server commences a reroll process to obtain a new st and Rₚ, updating the user entry in the database correspondingly.
8. The server informs the client of successful authentication or otherwise grants necessary access.

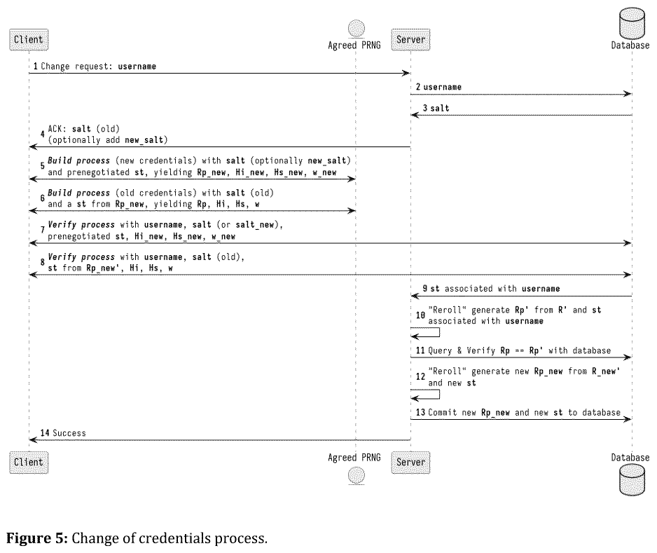

### Change of Credentials (FIG. 5)

In some embodiments, the process to update an existing user's credentials occurs as follows:
1. The client shall make a request to the server initiating the registration process, providing the username for which they wish to update credentials. (1)
2. Assuming the provided username exists (2), the server shall look up the corresponding user entry within the database (3), and respond to the client providing the user's existing salt for the old credential (4). In some embodiments, the server may also regenerate and temporarily store a new salt in preparation for the user's new credential and inform the client of this updated salt, should an update of the salt during credential change be desired.
3. The client shall now commence the build process for two separate credential trees:
   a. The client first performs a build process to construct a Merkle tree for their desired new credentials, using the updated salt, if it is available, or else the original salt provided by the server, and a prenegotiated or magic st as aforementioned. Let the proof hash Rₚ for this build process for the new credential be known as Rₚₙ. (5)
   b. In order to provide authentication for the credential change, the client shall perform a second build process with their original credentials and the original salt provided by the server, and with an st value derived from Rₚₙ. The exact process of this derivation may vary between embodiments. However, each distinct value of Rₚₙ should map to a distinct value of st. Various general cryptographic hash functions, for instance, may be suitable for this purpose. (6)
4. The client shall send the values of w, Hᵢ, and Hₛ associated with both build processes to the server.
5. Upon receipt of both sets of w, Hᵢ, and Hₛ, the server shall first perform a two-step verify process to validate the new credentials and ensure appropriate user authentication:
   a. The server will first perform a verify process with the set of w, Hᵢ, and Hₛ associated with the user's new credentials and the pre-shared st to verify the structural validity of the Merkle tree associated with the new credentials. Upon successful completion of the verify step, the server will have computed Rₚₙ; however, if the verify process fails, the server rejects the credential change attempt. (7)
   b. To ensure that the user making the request is adequately authenticated, the server will next perform a verify process with the set of w, Hᵢ, and Hₛ associated with the user's original credentials, deriving st in the same manner as the client does above from Rₚₙ. Should this verify attempt fail, the server will reject the credential change attempt. (8)
6. Once both verify processes succeed, the server performs the reroll process on the tree associated with the user's original credentials (10), using the st whi cverify that the resulting proof hash Rₚ′ matches the one recorded in the database; this step authenticates the user for the credential change, and the server shall only proceed if the proof hash values match. (11)
7. Upon confirmation that the Rₚ values of the user-provided original credential tree and the database-stored user entry match, the server performs a reroll process on the tree associated with the user's new credentials. (12) It then updates the database user entry with the resulting Rₚ and st, thus updating the user's credentials. (13)
8. The server informs the client of a successful credential change. (14)

However, one interesting aspect that warrants further discussion is the choice of P as used above. This parameter primarily functions to adjust the soundness of proof, given that it controls the size of w used for server-side verification. However, greater P increases server work and also selects more leaf hashes, which increases the probability that a given proof is reusable. Factoring in relative costs of attack on the Proof-of-Work component, Coelho's work recommends a value of P=8·log₂(N) for a tree with N leaf hashes; however, server administrators may wish to adjust this within reasonable bounds to provide greater levels of security for select users and use cases.

Additionally, consider the issue of possible attacks on the sent proof based on subtree comparison. Note that because the combination of Hs and w discloses leaf hashes at particular locations within the tree, under the current construction, an attacker need not build a full Merkle tree to ascertain that their tree does not correspond to the given proof. If, while brute-forcing credentials and generating their respective trees, for any given byte wᵢ in w, the wᵢ-th leaf node of the attacker's current tree does not match the corresponding hash in Hₛ, the attacker may prematurely terminate their attempt for that particular tree and thus subvert the brute-force resistance of the algorithm. Thus, a means of modifying the ordered nature of the leaves is needed, such that even if a particular wᵢ-th leaf node of the attacker's tree did or did not match the hash in Hᵢ, it can be mathematically proven that the attacker has no guarantee on tree equality; rather, they must build their tree in full and compare the root hash computed from the proof with that of their tree to fully ascertain equality.

In some embodiments, this process is achieved by a few modifications to the node hash calculation process and the tree structure. Specifically, when hashing two child nodes A and B in order to produce the parent node N, we shall combine the two child hashes in a way such that their order does not matter; as in, if hash N were in general given by a function η(A, B), then η(A, B)=η(B, A). Critically, note that this then gives the property that we may swap the subtrees of any given node in the Merkle tree without affecting the root hash R. Thus, using this construction, we may add an extra step after building the tree and before commencing with proof generation whereby we “shuffle” the tree—in some embodiments, the client shall generate a 256-bit random “shuffling llkey” K, where each of the first 255 bits determines whether a corresponding node in the tree (excluding the leaf nodes) shall have its subtree reversed. This way, when providing values of Hₛ for a given w, the client may provide leaf hashes for which the wᵢ-th leaf hash in the Merkle tree no longer necessarily corresponds to the wᵢ-th initial data block, making comparison of two trees impossible without fully constructing each and deriving their respective root hashes.

1. A method for generating zero-knowledge proofs and proofs-of-work from Merkle trees, comprising:
a. Generating a zero-knowledge proof and proof-of-work based on user-specific credentials or secrets, upon the basis of a Merkle tree, wherein the proof-of-work mechanism is founded on a method of a client disclosing a partial set of Merkle tree hashes and proof sequence w generated from a “proof” hash Rₚ comprising the root hash and any auxiliary information (such as a token or nonce) (altogether a “proof”) to the server for root hash validation, and leaf hashes are generated from blocks of data corresponding to the secrets in a way such that disclosure of any underlying block of data neither discloses the secret nor discloses other blocks, and that the Merkle tree cannot be parallelized;
b. Validating this “proof” using a corresponding server verifier which performs significantly less computational work, leveraging the partial set of tree hashes disclosed by the client, and any auxiliary information (such as a token or nonce) necessary for the server to independently compute the proof sequence w and verify it against the client-provided value, or validate root hash, “proof” hash, or other knowledge proof information.

2. The method of claim 1, wherein the method of block generation utilizes a Message Authentication Code (MAC) algorithm or similar construct with a keying approach designed to generate data vetting knowledge of the credential and enforce sequential construction of the Merkle tree.

3. The method of claim 1, wherein the client proof incorporates a “service token” st, or other nonce value provided by the server, to prevent trivial replay of the aforementioned “proofs”.

4. The method of claim 1, wherein the Merkle tree node hash function exhibits child node order independence, and wherein after the Merkle tree is built and before the “proof” hash or other proof material is generated, the Merkle tree is randomly shuffled to thwart trivial tree comparison by an attacker by means of a disclosed proof.

5. A system for securely registering, authenticating, and managing the credentials of users upon the basis of the method of claim 1, comprising:
a. A protocol for the registration of users via a multi-step process, wherein the client initializes a registration request, and, upon receiving basic necessary information such as a salt, provides an appropriate “proof” as aforementioned providing sufficient information for the server to authenticate the user's credentials via future “proofs”
b. A protocol for the authentication of users via a multi-step process, wherein the client initializes an authentication request, and, upon receiving basic necessary information such as a salt and “service token”, provides an appropriate “proof” to permit the server to ascertain the validity of the client's credentials.
c. A protocol allowing users to update or otherwise manage their credentials via a multi-step process, wherein the client initializes a management request, and, upon receiving basic necessary information such as salts, provides appropriate “proofs” to permit the server to not only authenticate the user, but to do so in the context of the credential management operations the user wishes to perform—for instance, providing new credentials in place of existing ones.

6. The system of claim 5, where protocols may incorporate a “reroll process” or any other process necessary on the server to update any “service token” or other nonce and any server-recorded root or proof hashes in a way that the updated values continue to authenticate the user given the updated “service token” or nonce, but that the original token or nonce is no longer valid.

7. The system of claim 5, where servers may incorporate a process to store additional information alongside that which is strictly necessary to authenticate the user (for example, storing additional salts during a credential change process), for purposes of increasing the scope of server user data updated during any protocol (for instance, providing a new salt during a credential change process).
